(19) United States
(12) Patent Application Publication
(10) Pub. No.: US 2005/0129286 A1
(43) Pub. Date: Jun. 16, 2005

(54) Technique using eye position and state of closure for increasing the effectiveness of iris recognition authentication systems

(76) Inventor: Christopher David Hekimian, Germantown, MD (US)

Correspondence Address: CHRISTOPHER DAVID HEKIMIAN, 13416 RISING SUN LANE, GERMANTOWN, MD, 20874, US

(21) Appl. No.: 10/737,036

(22) Filed: Dec. 16, 2003

(51) Int. Cl. G06K 9/00

(52) U.S. Cl. 382/117

(57) ABSTRACT

The invention, which is an embodiment of what the inventor calls, “Active Behavior Enhanced Iris Recognition Authentication”, employs a sequential iris imaging process where the authenticating party directs his or her gaze in specific directions, or closes their eyes for each image, so that an “eye state order” can be used to improve authentication security. Authentication security is strengthened based upon the reduced likelihood that a potential intruder would 1.) know what the correct sequence of eye states (i.e. up, down, left, right, camera view and closed) were associated with the control authentication template; 2.) be able to successfully “hack” the authentication server in order to gain access to the iris image information and also the eye state order information which would be required in order to fully compromise the authentication system. The technique embodied by the invention represents an overlay of a known, ordered sequence, over the iris recognition authentication process itself.

### PATENT REFERENCES CITED

| | | |
|---|---|---|
| 6483930 | November, 2002 | Musgrave, et al |
| 4641349 | February, 1987 | Flom et al |
| 5291560 | March, 1984 | Daugman |
| 6311272 | October, 2001 | Gressel |
| 6549118 | April, 2003 | Seal, et al |
| 6441482 | August, 2002 | Foster |
| 6542624 | April, 2003 | Oda |

No federally funded research was associated with the development of this invention.

### BACKGROUND OF THE INVENTION

1. Field of the Invention

The invention is a means of computer program or system or facilities access control relying in part, on iris-based identity verification. Iris recognition authentication methods can be used for controlling access to individual computer programs or databases, to networks and network based assets, or as a means of controlling access to fixed facilities or vehicles. The security afforded by the invention represents an improvement over the security available from conventional iris recognition approaches and has the potential to dramatically reduce the risk posed by a penetrated network or a replicated iris pattern incorporated on a contact lens.

The new invention is a technique for extending a basic iris recognition authentication process into one which includes elements of behavior that only the party seeking authentication would know how to duplicate. The additional elements can be imparted in such a way as to increase the security associated with the authentication process. The elements are imparted to the new authentication process by requiring an authentication sequence made up of a plurality of iris images, taken at predetermined intervals throughout the extended authentication imaging process. By closing one's eyes and/or diverting one's gaze in various directions during the course of the extended authentication imaging process, the character of the authentication sequence can be changed in a manner not possible with conventional methods. An intruder having a contact lens replica of an authorized user could not gain access to a secured system unless that intruder knew the pattern of eye closures and/or eye movements that were associated with a control template established by the true, authorized user. It will be shown that other important security advantages are associated with the new technique as well. The inventors refer to the new invention as “active behavior enhanced iris recognition authentication”. The new invention lends itself to any purpose that is currently served by a iris recognition authentication system, or other biometric security system.

Iris recognition-based authentication systems can be based upon direct image mapping or a comparison between biometric templates derived from image data. In practice, subject identification is positively achieved by comparing a digitally stored image, or biometric template derived from an image of an iris obtained at the point of access, to a known image or template stored on an authentication server. U.S. Pat. No. 4,641,349, “Iris Recognition System”, by Flom et al, and U.S. Pat. No. 5,291,560, “Biometric Personal Identification System Based on Iris Analysis”, by Daugman both describe schemes in which the iris is used to distinctly identify a person.

Currently, attacks on iris recognition authentication systems have been in the following forms;
1. Prosthetic attack, where a iris of an authorized person is obtained and is replicated onto a wearable contact lens;
2. Replay attacks, where a “man in the middle” monitors a data line and captures a successful authentication transaction that is replayed to the authentication server at a later time in order to gain unauthorized access.
3. Server attacks, where the computer hosting the authentication server is attacked so as to compromise the authentication registry associated with iris images or image derived templates so subsequent authentication transactions will allow the intruder in as a phantom user, or in place of a formerly authorized user;

The prior art includes measures that are intended to enhance the usability, reliability, performance and security of existing iris recognition based authentication systems.

2. Prior Art

Prior art related to iris recognition authentication systems includes a system that which addresses the possibility of migrating biometric features (U.S. Pat. No. 6,311,272, “Biometric System and Techniques Suitable Therefor”); an enhanced imaging technique for iris scanning devices (U.S. Pat. No. 6,483,930, “Iris Imaging Telephone Security Module and Method”); a system to defend against “replay attacks” by rejecting authentication candidates which are “too exact” to one of a set of previous authentication submissions (U.S. Pat. No. 6,549,118, “Security Apparatus and Method”); a system for iris recognition authentication that is integrated on a microchip (U.S. Pat. No. 6,441,482, “Biometric Device with Integrated CMOS Image Sensor”); and a system presented by Oda, which stimulates certain biogenic reactions in the eye during the authentication sequence so as provide assurance that the iris being imaged is authentic and not an image itself (U.S. Pat. No. 6,542,624, “Iris Code Generating Device and Iris Identifying System”).

None of the prior art addressed a means by which a sequence of authentication images, made up of iris images and images that were the result of deliberate eye movements, which could include eye closures, could be used in order to increase the security associated with the authentication transaction. The following discussion is a comparison of the method taught by Oda with the new method. It is provided in order to make clear the important distinctions between the two systems.

Whereas the system taught by Oda does involve the analysis of a sequence of iris images, the nature and purpose of the sequence are clearly different. In the following sections that describe the summary and details of the new invention we will set forth how the new system uses deliberate actions on behalf of an authorized user in order to dramatically increase the number of potentially valid authentication sequences from which the candidate authentication sequence must be chosen. The set of all potentially valid authentication sequences can be considered the “authentication space”. By expanding the authentication space, we can bring about the case where having an exact duplicate of a valid user's iris on a contact lens would not be sufficient to gain access. In order to successfully authenticate, a would be intruder would need to know the order and timing of an entire sequence of authentication images and to exactly duplicate the eye movements associated with each successive image. In contrast, Oda presents a technique where external stimulus is applied in the form of modulated light, air motion and prompted eye movements in order to stimulate responses that only a living eye can effectively duplicate.

Oda's method can reduce the risk posed by replicated iris pattern incorporated on an image not worn on a contact lens. If a would be intruder were in possession of a contact lens with a replicate of a valid user's iris imprinted on it, should the biogenic responses to the automatic and randomly generated biogenic stimuli appear sufficiently lifelike, the system could be effectively compromised. It cannot be assured that the use of contact lenses will cause a detectable effect on dynamic pupil dilation. Furthermore, stimuli causing blinks on a bare cornea are just as likely to cause the same response on a cornea masked with a contact lens. Oda's method does provide important protection against the “replay attack” where a data line is monitored and a successful authentication sequence is captured by a would be intruder. At a later time the captured authentication sequence is replayed in order to gain unauthorized access. The nature of Oda's randomized iris code generating system is a sound defense against such an attack. Oda's method does not increase the size of the authentication space (the number of potential valid authentication sequences from which an intruder would have to guess in order to successfully authenticate).

Functionally, a potential intruder with a replica of a valid user's iris on a contact lens would have little trouble being admitted to a system protected by Oda's system because the intruder's eye is alive and can be expected to respond to light and to moving air and to visual prompts in accordance with the iris code generated by the system. However, a replay of the authentication process by a “man in the middle” would not likely be successful.

With the new invention, a potential intruder with a replica of a valid user's iris on a contact lens would have a great deal of trouble defeating the system because that user would conceivably, have to know when to close and open their eyes, and when to look right, left, up, down, and into the lens(es) of the imaging device(s), throughout the entire authentication sequence. In effect, a new, additional layer of security is associated with the new technique which is in the form of the extended authentication template consisting of an ordered sequence of images of the authentication candidates eye region. The ordered sequence of eye movements constitutes a kind of password, contained implicit with the iris imaging process.

A replay of the authentication process associated with the new method initiated by a man in the middle would succeed unless another method, such as Oda's method or the technique described in U.S. Pat. No. 6,549,118 was employed supplementary to the new technique.

With respect to the server attack scenario noted previously, the recommended implementation of the new invention adds up to two additional layers of security. With the new technique, an offline attacker would not only need to capture and or compromise the authentication server-maintained iris image data registry, the attacker could also be required to capture a registry defining the correct ordering of the iris images and the correct imaging devices associated with each image, if a multiple imaging device configuration is employed.

### SUMMARY OF THE INVENTION

The new system adds the elements of eye movement, timing, and imaging device selection to existing iris recognition-based authentication processes.

The new invention, is unique with respect to the basic themes of all existing iris recognition based authentication techniques due to the distinguishing characteristics of;
1. Requirement of multiple iris scanning procedures for each authentication process
2. Requirement that the multiple iris scanning procedures be made up of a preestablished sequence of images of the eye which can include images with the eyelid closed, and/or the eye directed into different directions.
3. Ability to require that the multiple iris scanning processes conform to a predetermined time profile.
4. Ability to require that the multiple iris scanning process be taken among a plurality of imaging devices in conformance with a predetermined profile.
5. Ability to require that the authentication server maintain registries of iris recognition data and image order data.

As a basis for example, we set forth an active behavior enhanced iris recognition system using one imaging device and based upon a 5 image template and an image set consisting of 6 possible eye states, which are camera view; view left; view right; view up; view down; and closed eye. We assume an iris scanning time of 1 second, per scan which is consistent with the current state of the art. We allow a total authentication imaging interval of 7 seconds. For simplicity, we require that the first image be a camera view, reference image consistent with a conventional iris recognition system. For the camera view image, the authentication candidate would look directly into the imaging device. The system that we have described would require 7 seconds for the acquisition of 5 images. System users would be instructed to allow approximately 1.5 seconds for each eye state. Taken with the required scan time of one second, the system allows for a reasonable degree of variation in user timing while still collecting each image of the eye, in the correct state. Successful authentication with the example system provided would require an iris image which corresponds correctly with one maintained by the authentication server, the iris would have to be living, in that eye motion and/or eye closures would be required, and a correct sequence drawn from a set of 1296 (6⁴) would have to be known by the party seeking authentication. Most password protected systems block accounts after 3 to 5 unsuccessful log in attempts. The example system we have described is based upon iris image match and correct ordering of 4 supplemental eye state images each of which can be in one of 6 different states. Faster imaging systems would allow an increase in the number of potentially valid authentication sequences without requiring an extension of the total authentication imaging period of 7 seconds. If the reference image were not required to be the first image, or if an additional image was added to the authentication sequence, the size of the authentication space would be increased by a factor of 6. Each additional image added to the authentication sequence would increase the size of the authentication space by a factor of 6.

It is possible to increase the size of the authentication space dramatically relative to the example described above by facilitating the use of two or more imaging devices, managed by the same image processing station. A dual imaging system based upon the criteria described above would correspond to an authentication space of 20736(12⁴) possible sequences. The expansion of the authentication space is realized by further requiring that the authenticating party exhibit the correct eye state, of 6 possible, relative to the correct one of two imaging devices. Adding additional imaging devices increases the size of the authentication space exponentially consistent with the following equation:
size of authentication space=(n·a)^{N-1} (1)
where “n” is the number of imaging devices, “a” is the number of different eye states, and N is the total number of images provided in the authentication sequence.

Someone skilled in the art of software engineering can appreciate that the system, so described can be implemented solely by changes to software. Therefore, overall security is enhanced based upon “liveness” assurance and enlargement of the authentication space, and decreased server vulnerability, by what can expected to be a low cost per instance, software upgrade to existing systems. In order to support repeatability in eye movements, the recommended implementation would include viewing targets at fixed distances above, below and to the right and left of the imaging device.

### BRIEF DISCUSSION OF FIGURES

FIG. 1 illustrates the basic components of the active behavior enhanced iris recognition system that we have developed. The hardware components of the system are the same as existing, conventional iris recognition systems. Differences lie in the software which controls the operation of the system. Furthermore, item (1) of the system, the wall-mountable viewing target would not be necessary in a conventional system. The wall-mountable viewing target is used in order to give parties seeking authentication targets to focus on during the authentication process. The use of the target helps ensure consistency of repeated imaging processes. Item (2) is the iris imaging device, or camera. For reasons of clarity, only one set of imaging device and viewing target is shown. Some configurations could allow for a plurality of imaging devices and associated viewing targets. Item (3) is the iris imaging processing station which could be a simple, standard personal computer CPU unit capable of supporting a plurality of imaging devices. Item (5) is the authentication server which is connected by data medium (4), or network, to a plurality of iris imaging stations consisting of items, (1), (2), and (3).

FIG. 2 is an illustration of the operational components of the iris scanning station. It can be interpreted as follows; Authentication candidate (10) wishes to access a protected network access or facility secured by the new system for active behavior enhanced iris recognition. Authentication candidate (10) orients herself a fixed distance, usually about 2 feet, from the lens of the imaging device (2). A privacy shield (8) is used in order to keep an individuals authentication process private. The authentication candidate (10) initiates the authentication process by depressing a start button (9) or keyboard key. A software algorithm stored in the iris imaging processing station (3) is carried out which effects a sequence of regularly timed images to be taken using imaging device (2). Imaging indicator (4) lights while images are being recorded. While the sequential imaging process is underway, authentication candidate (10) enhances the security of the authentication process by carrying out active behaviors in the form of eye movements and eye closures, in a sequence known only to her and to the authentication server (not shown). The technique that we recommend requires that the first image taken is of the full iris with authentication candidate (10) looking straight into the lens of imaging device (2). Subsequent images are intended to capture a fixed number of “eye states”, which will be used to further authenticate the authentication candidate (10). In practice, authentication candidate (10) focuses her eye on one of 4 targets which are provided on the wall mountable viewing target (1) or she can focus directly at the lens of the imaging device (2), or she may close her eyes. After a predetermined and fixed number of images have been taken, at least one reference image, or biometric template derived from the reference image, is configured into an authentication packet with the additional images or templates that represent the eye states, and the authentication packet is transmitted through the data medium to the authentication server. An alternative technique is also presented where a correlation process is performed by iris imaging processing station (3) and a vector coded based upon the eye movements is transmitted to the authentication server in lieu of having to send larger amounts of data or images through the data medium to the authentication server. The new system that is presented here has equal benefits whether the iris recognition system at hand correlates iris images directly or whether it reduces the image to a data template first, and performs matching based upon the reduced data in the template. For this reason and for the sake of readability, we will use the term “image data” to refer either to the raw image, or to the biometric template data which can be derived from the raw data. The authentication server carries out a search based upon the reference image data sent and the iris image data that it has stored in it's iris image data registry. If a match is found, then the authorized user is tentatively identified. Another registry which contains the order of the eye states associated with the tentatively identified user is checked with the control eye state vector was received. If a match is found then authentication is considered successful, identification is no longer considered tentative and the identified user is considered to be one in the same as the authentication candidate (10).

FIG. 3 describes the same process discussed with respect to FIG. 2, but in tabular form. The table columns, from left to right, describe the actions taken part by the authentication candidate, and the functions of the iris imaging station and the authentication server, respectively. The “rows” as viewed from top to bottom, represent increasing time from the start, to the finish of the authentication process. The bold arrows represent data being conveyed to and from the iris imaging station and the authentication server.

FIG. 4 shows a drawing of a human eye and iris (1). Also shown is a simple symbol alphabet of {a, b, c, d, e, f} which are representative of the eye states we have shown and adopted for our example (2). Item (3) shows an example sequence of eye states that could be associated with a 5 image active behavior enhanced iris authentication system. Item (4) shows the order vector that would correspond with the sequence of eye states shown in (3). It can be noted that for this example, the authentication space has a size of 6^{(N-1)} where N is the number of images contained in the authentication sequence. For our example, N=5 and there are exactly 1296 possible order vectors that can be associated with the 4 eye states following the reference image. Timing data is shown with item (3). In fact, it is important that adequate timing and synchronization is maintained between the actions of the authentication candidate and the operation of the imaging device. For our example, the time intervals shown underneath the eye states in (3) represent the intervals in which the eye state must be as shown in order to allow for the iris imaging system to correctly execute a 1 second exposure of the iris or eye, image. The following figure more clearly defines the temporal relationships between authorization candidate actions and imaging system function.

FIG. 5 is significant in that it shows the temporal relationships that must be maintained in order for our sample instantiation of the system to function. The primary limiting factor governing the functionality of the system is the minimum imaging time for the iris imaging device. The minimum imaging time associated with modern iris scanning systems is approximately 1 second. The imaging times are represented on FIG. 5 as the white boxes with the word “image 1”, etc. in them. The system will tend to reject authorized users if the authenticating party fails to maintain a given eye state throughout each 1 second imaging interval. FIG. 5 shows the case where the actions of the authentication candidate occur within time windows sufficiently large (around 1.5 seconds each) so that the system will function correctly. The windows defining the actions of the authentication candidate are represented by the shaded boxes above the white boxes. The lateral positions of the shaded boxes and their exact lengths cannot be considered exact because they are determined by the authentication candidates eye movements. Inside the shaded boxes are labels which define which eye state the authentication candidate should be emulating in order for authentication to succeed. The uppermost row over the time line shows the eye states that were chosen for our example, over the eye state windows for which they apply. In practice, the users of the new system would be told that a 1 second exposure of their eye will take place automatically every 1.5 seconds. Further, the user would be instructed to allow approximately 1.5 seconds for each eye state they choose for their authentication sequence. It is reasonable to expect that some practice with the system can reduce the likelihood that type 2 errors, where a valid user is rejected, will occur.

FIG. 6 shows two alternative structures for the authentication data packets that would be conveyed from the iris imaging station to the authentication server. We have discussed thus far, two general means for carrying out eye position correlation. One involves the transmission of image data to the authentication server, where image correlation with user specific or generalized eye position templates can occur, the other alternative involves generalized correlation done prior to communication, by the iris image processing station. The figure shows that the first alternative requires that a significantly greater amount of data be communicated from the iris image processing station to the authentication server than would be the case with the second alternative. The second alternative allows for the eye state correlation process to take place local to the iris image processing station and for the resulting order vector to be conveyed to the authentication server in lieu of a plurality of image data. The eye state correlation methods are described in greater detail in the detailed description section of this document. The authentication data packets could include data which identified which, of multiple imaging devices was used for a given set of image data.

FIG. 7 is a functional flow chart describing one of many possible techniques for implementing the scanning station side functionality. For clarity, only one imaging device is assumed, as that condition is consistent with the recommended implementation and extension to a plurality of imaging devices, based upon the figures provided, is straightforward. FIG. 7 illustrates how the first alternative, involving eye state order processing on the server side, could be implemented by someone skilled in the art of computer programming or digital circuit design. Those skilled in the art of computer programming or digital circuit design will appreciate the fact that there are numerous ways to exact the same functionality set forth in this figure. It was our intent to choose the methods most illustrative of the important and unique aspects of the new invention to be included in the FIGS. 7 through 10. The authentication transaction is initiated by the party seeking authentication (authentication candidate). Immediately subsequent to the activation of the START pushbutton, the memory buffer local to the iris image processing station is cleared and any transient data values are cleared or initialized. An integer value, “i” is set to 1 and will serve as a pointer to which image, of the overall sequence is being scanned. A clock or timer function local to the iris image processing station is enabled and proceeds to count. The “i-th” (first or reference image when i=1) is scanned in the first second of the authentication process. The resulting image, or a template derived thereof, is stored to the local memory buffer. Assuming that the authentication sequence is designed to process more than one image, and N≠1, a delay period of approximately 500 ms occurs after which the pointer i is incremented and the next image is scanned and added to the local memory buffer. The process is repeated until all N images have been scanned. The example representative of the previous figures had N=5. Once all of the images have been scanned and added to the local buffer, the buffer contents are configured into a communication packet and transmitted to the authentication server. At this time the iris scanning station waits for the result of the authentication transaction from the authentication server. When the result is returned, the appropriate authentication result indicator is illuminated, access to the secured entity is either granted or denied, and the scanning station awaits initiation of the next authentication transaction.

FIG. 8 represents an example of how scanning station side functionality might be realized such that eye state correlation is performed local to the image processing station. It should be noted that because the recommended approach for the new system does not involve the storing of any user derived biometric data, this alternative will require the eye state correlation process to be done using generalized templates and not templates derived from images of an actual user. The discussion regarding FIG. 11 will elaborate on the recommended method for generalized eye state correlation.

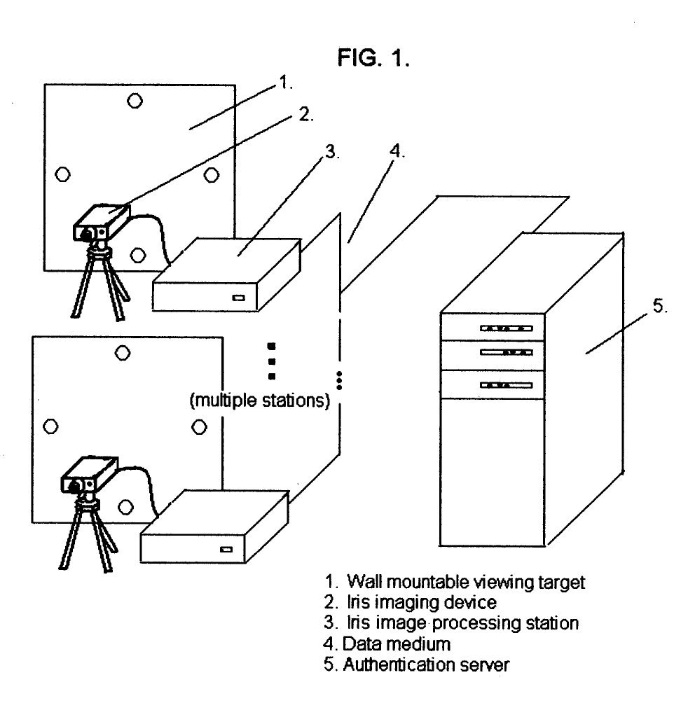

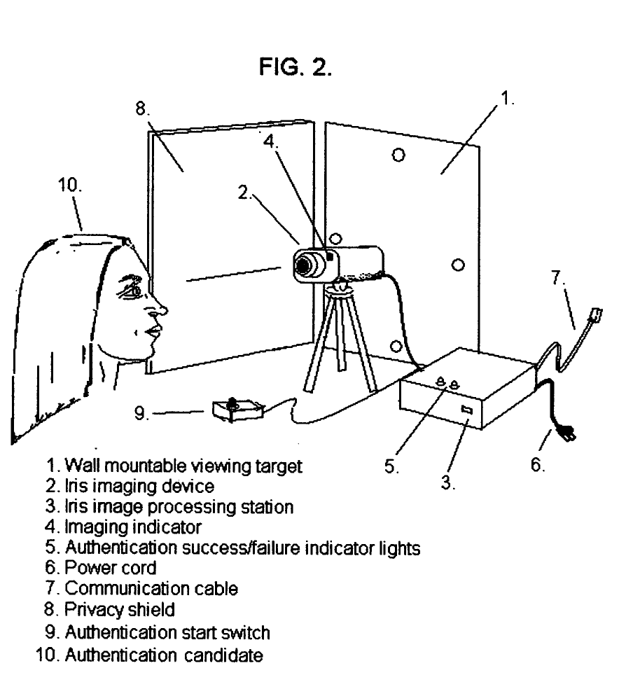

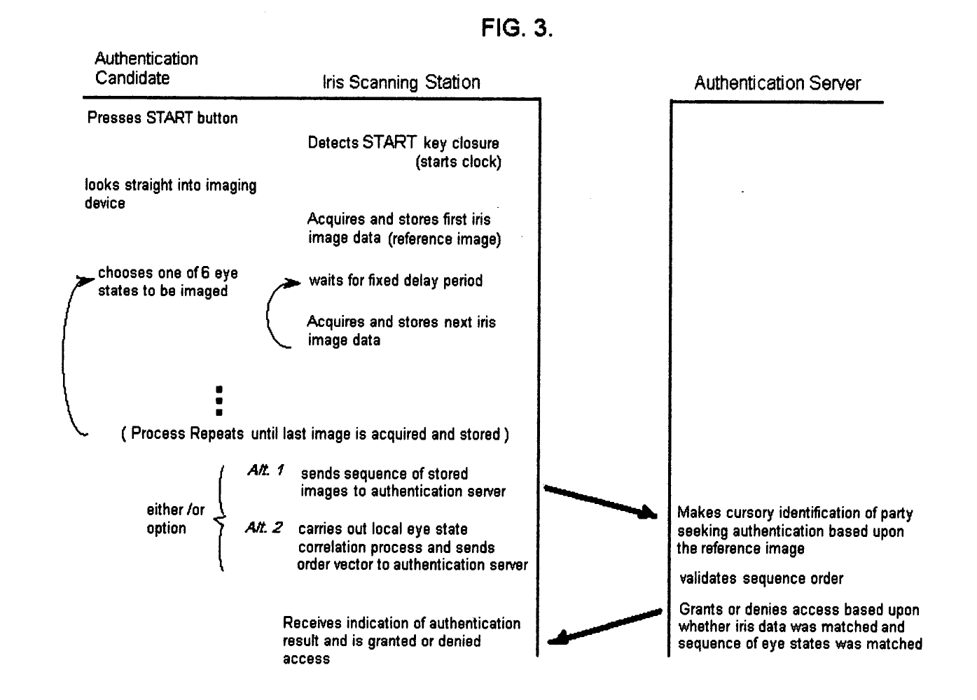

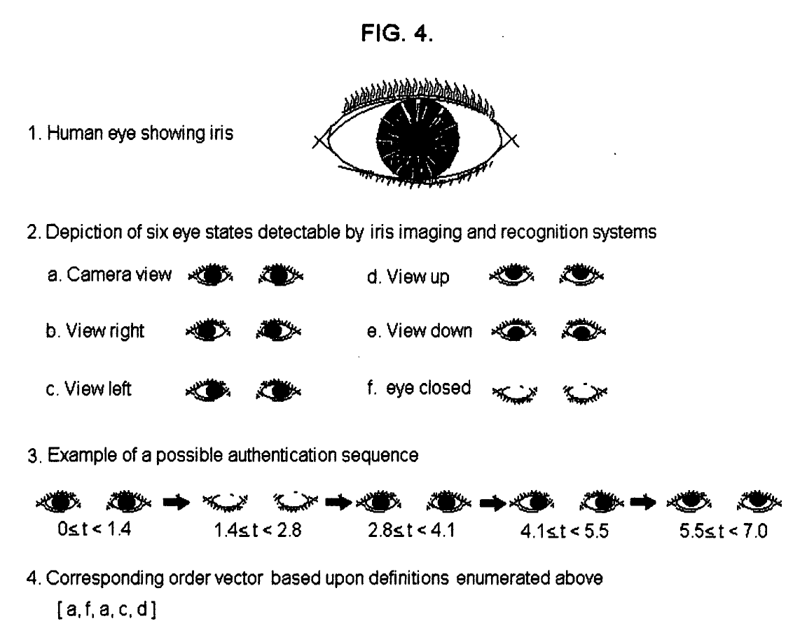

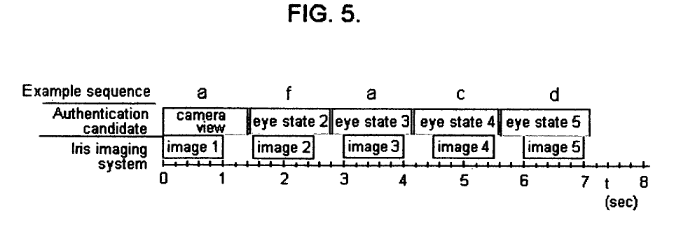

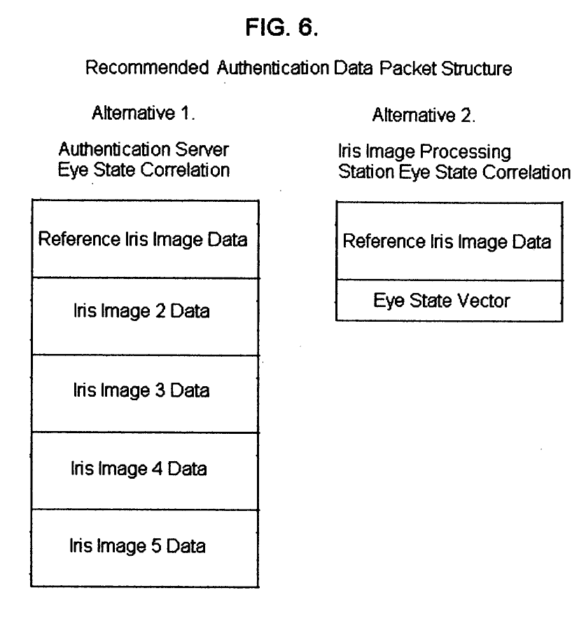

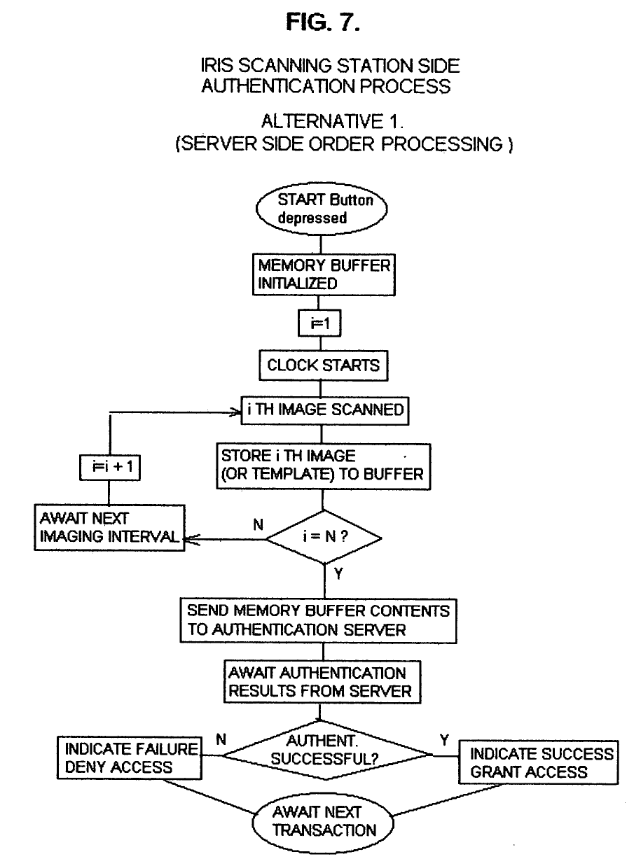

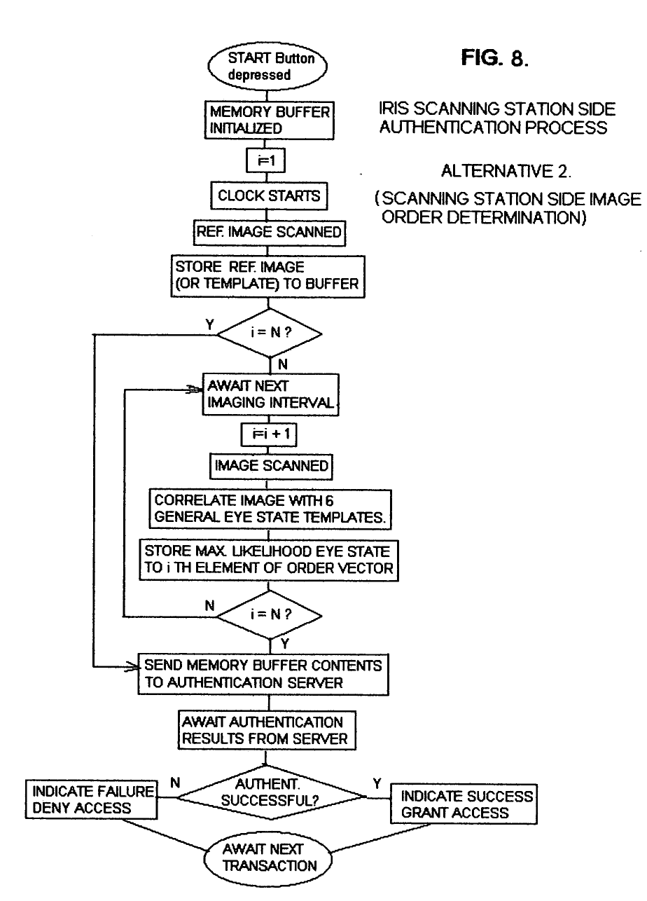

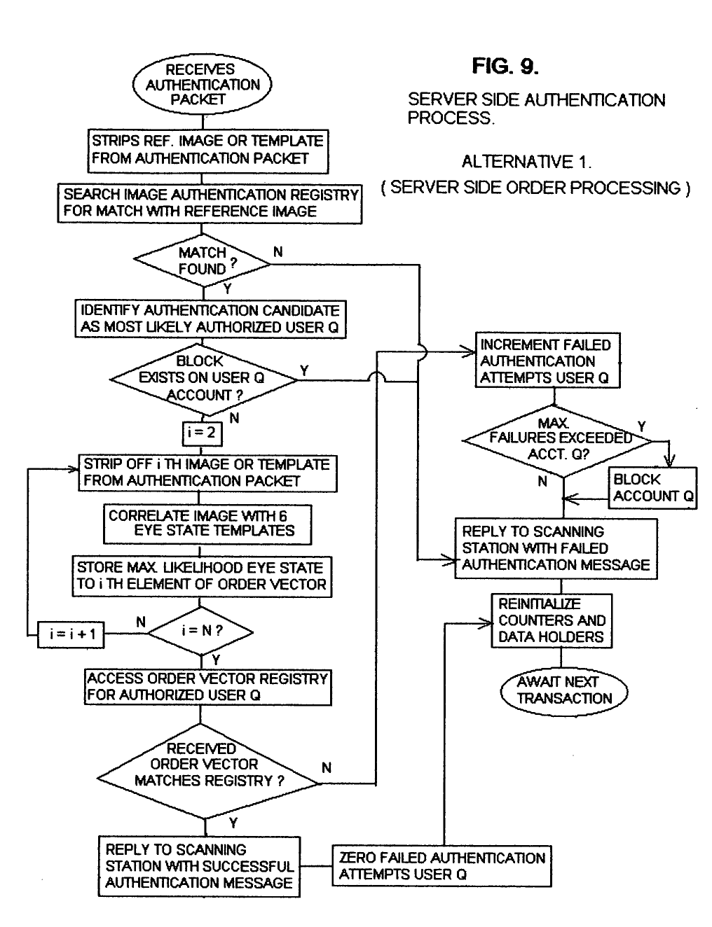

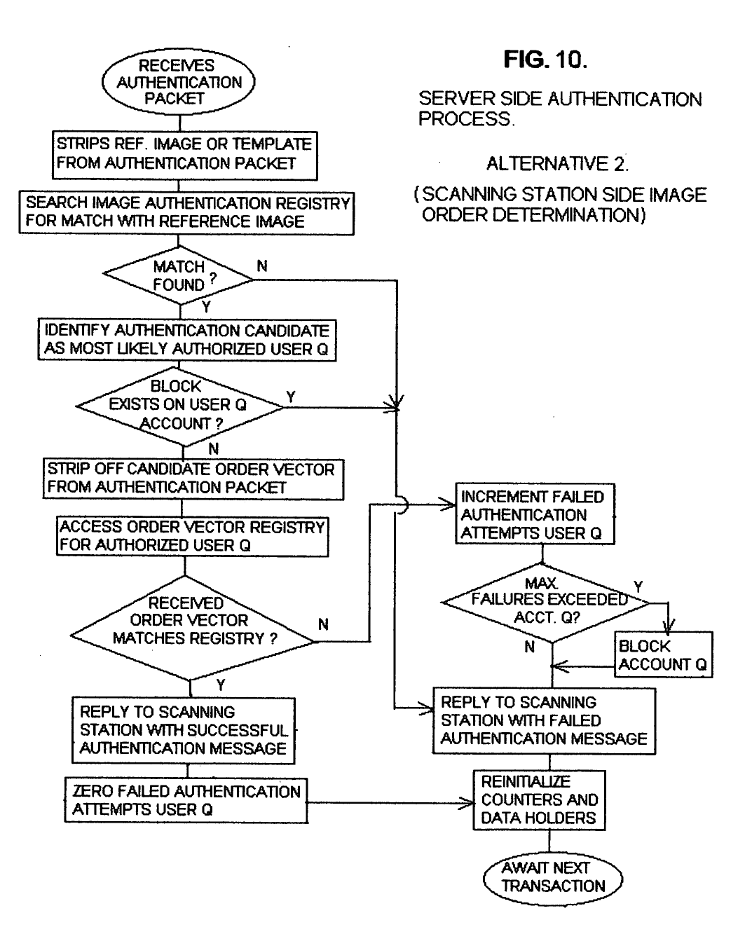

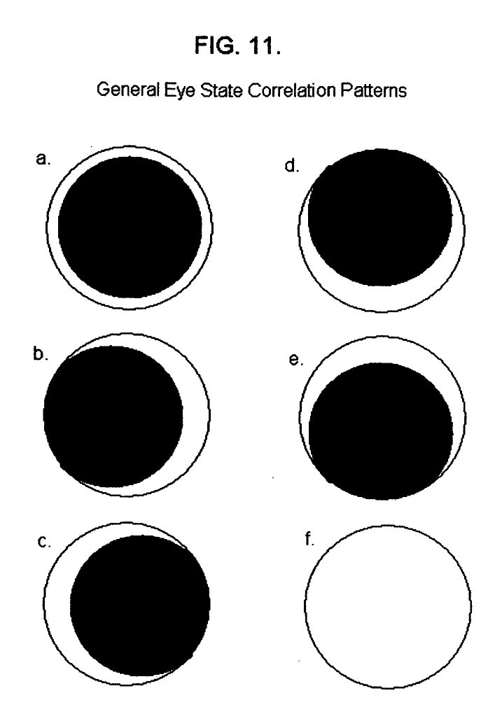

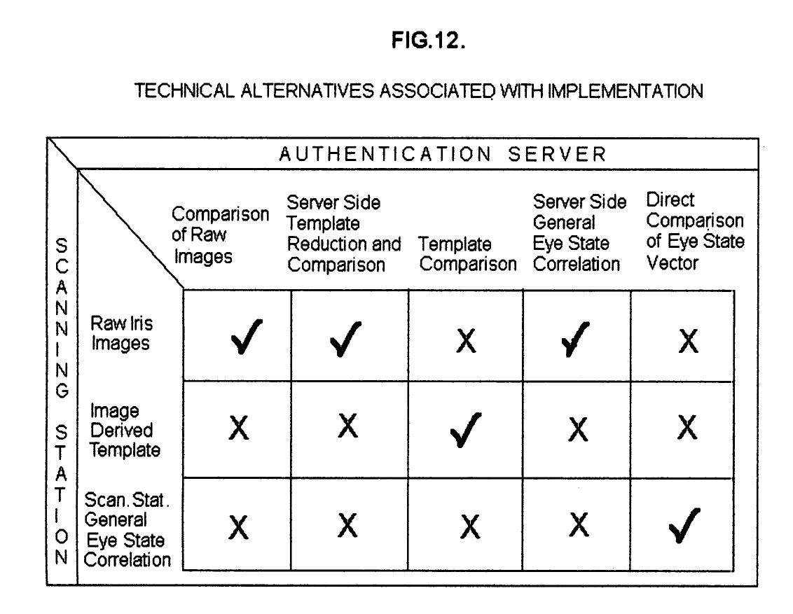

Consistent with FIG. 8, the authentication transaction is initiated by the authentication candidate. Immediately subsequent to the activation of the START pushbutton, the memory buffer local to the iris image processing station is cleared and any transient data values are cleared or initialized. An integer value, “i” is set to 1 and will serve as a pointer to which image, of the overall sequence is being scanned. A clock or timer function local to the iris image processing station is enabled and proceeds to count The reference image is scanned in the first second of the authentication process. The resulting image, or a template derived thereof, is stored to the local memory buffer. Assuming that the authentication sequence is designed to process more than one image, and N≠1, a delay period of approximately 500 ms occurs after which the pointer i is incremented and the next image is scanned. Correlation of image derived data is performed using the generalized templates illustrated in FIG. 11 and the eye state of maximum likelihood is added as the i th element of the eye state vector. Should i≠N, another delay period of 500 ms is incurred, the pointer i is incremented, the i th image is scanned and correlated and the eye state of maximum likelihood is incorporated as the i th element of the order vector. The process is repeated until all N images have been scanned and correlated and the results incorporated into the order vector. After the above process is complete, the authentication packet which includes one set of image data and one eye state vector is conveyed to the authentication server. At this time the iris scanning station waits for the result of the authentication transaction from the authentication server. When the result is returned, the appropriate authentication result indicator is illuminated, access to the secured entity is either granted or denied, and the scanning station awaits initiation of the next authentication transaction.

FIG. 9 outlines the functionality of the authentication server which is consistent with the first alternative implementation which carries out eye state correlation on the server side. It is intended to be understood that multiple imaging device systems would be facilitated in a manner identical to how is described with the exception that images and image derived data would be tagged with an identifier based upon the imaging device that generated the data.

The server side authentication process begins when the authentication server receives an authentication packet. The server strips the reference image or image template from the authentication packet and searches for a match among the image data that it has stored in it's iris image registry. Many biometric authentication systems do not store raw data or templates directly in their authentication registries. Instead, hash products or the product of one way (non-invertible) functions are stored. In this way, should the registry be compromised, the actual biometric data associated with individual users is not directly compromised. The authentication server configuration that we present can be designed to employ hash functions. The hashing process is not indicated on the figures, however, and no further discussion relative to them will be offered in this context. Should a match be found between the reference image provided by the iris scanning station and one of the users represented in the authentication server iris data registry, we tentatively identify the authentication candidate as “User Q” and continue the authentication process. Should a match not be found, the server replies to the scanning station with a “failed authentication” message, interim data values are reinitialized, buffers are cleared and the server awaits receipt of the next authentication packet. For the case where a tentative identification has been made, the server checks to see whether a block has been put on the account. This represents a safeguard against a potential intruder trying exhaustively, tens or hundreds of eye state sequences in order to defeat the new system. If the account has not been blocked, the image counter “i” is initialized to 2 and the i th set of image data is stripped from the authentication packet. The i th set of image data may be in the form of a raw image or of a biometric template derived from the image. In either case, the i th set of image data will be correlated against either a generalized set of eye state images or templates, or against a set of image data for each eye state derived directly from the authorized user that can be maintained on the authentication server. To maintain the requisite set of 6 eye state image data (for the example given) for each of a large number of potential users, requires a significant amount of data storage even when templates are used. The use of generalized eye state templates offer a clear advantage in this respect The result of the eye state correlation will be, in our example, a letter from the set {a, b, c, d, e, f}. For each of the correlations, the most likely symbol from the set shown is stored as the i th element of the candidate eye state vector. Once each consecutive set of image data is stripped from the data packet and correlated against the possible eye states, and the result incorporated into the candidate eye state vector, a separate registry, maintained by the server in order to store the eye state vectors, by authorized user, will be accessed. Should the candidate eye state vector match the eye state vector for user Q which exists on the server, authentication is deemed successful and the identification of user Q is no longer deemed as tentative. The authentication candidate is considered to be user Q, an “authentication successful” message is sent to the scanning station and initialization takes place, including zeroing of the number of consecutive failed authentication attempts for user Q. Should the candidate eye state vector not match the one stored on the server, the number of consecutive failed authentication attempts is incremented by one and a block is placed on the account if the maximum number of acceptable failed attempts is exceeded. A “failed authentication” message is returned to the scanning station and interim data holders in the server are initialized and the server awaits the next transaction.

FIG. 10 outlines the functionality of the authentication server which is consistent with the second alternative scanning station side implementation. The second alternative method carries out eye state correlation local to the iris image processor so that only the candidate reference iris image data and the candidate eye state vector need to be conveyed to the authentication server.

The server side authentication process begins when the authentication server receives an authentication packet. The server strips the reference image or image template from the authentication packet and searches for a match among the image data that it has stored in it's iris image registry. Should a match be found between the reference image provided by the iris scanning station and one of the users represented in the authentication server iris data registry, we tentatively identify the authentication candidate as “User Q” and continue the authentication process. Should a match not be found, the server replies to the scanning station with a “failed authentication” message, interim data values are reinitialized, buffers are cleared and the server awaits receipt of the next authentication packet. For the case where a tentative identification has been made, the server checks to see whether a block has been put on the account. If the account has not been blocked, the candidate eye state vector is stripped from the authentication packet. The candidate eye state vector is compared element by element to the control eye state vector that is maintained on the authentication server in a separate registry, designated as corresponding to user Q. Should the candidate eye state vector match the eye state vector for user Q which exists on the server, authentication is deemed successful and the identification of user Q is no longer deemed as tentative. The authentication candidate is considered to be user Q, an “authentication successful” message is sent to the scanning station and initialization takes place, including zeroing of the number of consecutive failed authentication attempts for user Q. Should the candidate eye state vector not match the one stored on the server, the number of consecutive failed authentication attempts is incremented by one and a block is placed on the account if the maximum number of acceptable failed attempts is exceeded. A “failed authentication” message is returned to the scanning station and interim data holders in the server are initialized and the server awaits the next transaction.

FIG. 11 depicts 6 eye state correlation patterns that can be used to determine whether the authentication candidate is looking directly into the imaging device or to the right, or left, or above or below it, or whether the eye is closed. The figure does not show the detail of the eye or the iris because such details are not relevant to the position determination of the eye. The generalized eye state correlation process is best carried out by comparing a contrast enhanced image of the eye, which would effectively convert the image to a black and white image, with each of the correlation patterns shown. The generalized eye state correlation process will be discussed in greater detail under the detailed description section of this document The use of the generalized eye state correlation technique allows eye state correlation to take place local to the iris imaging station and does not require a plurality of iris images to be transferred to the authentication server. The use of the generalized process also allows for more efficient use of processing capacity and data storage by the authentication server. An alternate method for eye state correlation that could be carried out on the server side would involve the direct matching of raw image data or biometric templates maintained by the server, with each of a set of N images provided by the iris imaging station. The alternate method would employ standard iris matching algorithms, as set forth in references [1] and [2], and would require that 6 sets of raw image data or templates be maintained by the server, for each authorized user.

FIG. 12 is a table intended to clarify a plurality of technical alternatives associated with implementation of the eye state authentication function. On the left hand side of the table are listed the technical alternatives associated with the scanning station functionality, in terms of imaging processes. Therefore, the first row of the table represents all possible configurations where the scanning station provides raw image data to the authentication server. The columns of the table, considered with respect to the first row, indicate that the authentication server could conduct eye state authentication based upon the three (checked) ways. In particular, correlation could be based upon the raw iris images themselves, upon templates derived by the server based upon the supplied raw data, or eye state authentication could be based upon a server side process of generalized eye state correlation. The rows marked by “X” would not be applicable. The second row of the table defines the overall configuration options available when the scanning station reduces raw images to biometric templates and provides them to the authentication server. In particular, we note that only the option of comparing templates on the server side exists. Similarly, should generalized eye state correlation be performed on the scanning station side, only the server side option of comparing eye-state vectors directly is operative.

Due to the plurality of implementation options, discussion of recommended implementation will address all of the checked options appearing on the FIG. 12 table. The elements common to all of the technical alternatives are; the means for authentication based upon eye states; the hardware configuration required in order to support the eye state authentication process; the process by which an authentication candidate carries out an authentication sequence; the hardware functionality during the image acquisition processes; the structure of the authentication sequence with respect to the one camera view reference image and N−1 eye state images; and the definition of eye states which forms the basis for distinguishing users based upon a sequence of eye states.

### DETAILED DESCRIPTION OF THE RECOMMENDED IMPLEMENTATION

The recommended implementation of the active behavior enhanced iris recognition authentication system that we introduce here is sensitive to the observable characteristics of the iris, as are all other iris recognition based systems, as well as eye state order. Consistent with the recommended implementation, eye state is defined as “camera view” in which the authentication candidate looks straight into the imaging device, or “view right”, “view left”; “view up”; “view down”; or “eyes closed”, which are the states where the authentication candidate fixes his/her gaze to the right or left or above or below the imaging device, or closes his or her eyes, respectively. Depending upon demonstrated system performance under the widest range of operating conditions, “eye closed” imaging may be omitted from the available eye states. The sequence of eye states, which are inherently time sensitive due to the automated sequential imaging process constitutes a particular eye state order. Even if a positive identification of an authentication candidate were to be indicated based upon a camera view reference image, the new system does not consider the authentication process to be complete until the authentication candidate carries out the eye states, in order, as was uniquely defined by the known authentic user at a previous instance. It is understood that the new concept which is presented here could involve a greater or lesser number of eye states, more than one imaging device, and/or a plurality of various types of reference image data.

Multiple imaging device systems would be facilitated by tagging each image or set of image derived data with an identifier based upon the imaging device that originated it. Furthermore, each imaging process would involve the simultaneous operation of all imaging devices in the system. All images, or image derived data would need to be processed or otherwise conveyed to the authentication server. The processing of authentication sequences from multiple imaging device systems would be associated with images extraneous to the authentication process in that they would not contain iris or eye position data and would be redundant with respect to the data contributed by the imaging device actually engaged by the authenticating party. Such a system, by most standards would be considered inefficient and for that reason, multiple imaging devices are not considered with respect to the recommended implementation. For the sake of clarity and brevity, our detailed discussion will pertain to a recommended implementation similar to the system described with respect to the figures.

The active behavior enhanced iris recognition authentication system can be implemented with existing iris recognition reading hardware and with minor modifications to existing software. Conventional iris recognition sensing apparatuses are commonly peripheral to a personal size computer. The common configurations would not require any hardware changes in order to achieve the full functionality of the new method. It is possible to engineer the system in a way that the required functionality is “built in” and a separate device for processing or communication is not required. The methods described for iris imaging, and eye state sensing, storage, communication and authentication decision making can each be performed readily and effectively based upon a number of different algorithms that could be implemented by a skilled computer programmer in a host of different computer languages and language configurations. An individual skilled in the art could employ “program in chip” technology and other microchip based technologies in order to achieve full scanning station functionality consistent with that described throughout this document.

The remainder of this section will address in detail the procedural components of the recommended implementation of the new system. These procedural components are the processes of establishing an authentication profile and carrying out an authentication transaction. It is the nature of the underlying technologies that more than one technical method can be used in the procedural components. A choice between the technical methods would be made based upon resource availability, including processor speed, physical storage and communication bandwidth, and overall system performance and reliability. The following sections include reference to some of the alternative technical approaches which could be employed in the overall system and which when applied selectively, would constitute a recommended implementation for a number of prevailing conditions involving resources and performance requirements.

Setting up the Authentication Profile

Similar to how a password system must establish what the valid password to be associated with a user's account, the reference iris image and the eye state order components of the new technique must be established with the authentication server prior to the time a user can authenticate using the system. Both sets of data are collected by means of a timed, sequential imaging process directed towards the user's eye.

The process for setting up an authentication profile for a user begins by requiring the user to prove identity using a photo ID or other authoritative means. The user is then provided instructions on how to use the system. In particular, the user is advised how the system works and informed that it relies on a sequence of images taken of the eye, so that the motion of the eye, over several seconds, is captured during a given number of imaging intervals. The use of the viewing targets is described to the user (the viewing targets may be labeled A, B, C, etc.) and the user is informed that the authentication process that they will be required to memorize and duplicate at each successive authentication attempt, will be begun by gazing into the camera for about 1.5 seconds, and then at any of the viewing targets, or by closing their eyes, for about of 1.5 seconds each, at each successive 1.5 second interval until each of “N” (4, 5, 6 etc.) images are taken. The iris scanning station can be programmed to emit an audible signal after all images have been completed. The user should be allowed an opportunity to ask questions and should be allowed some time with privacy, to practice his/her authentication sequence.

Once identification has been verified and instruction has been given, the user initiates the timed imaging process by depressing a pushbutton or otherwise initiates the recording process with a mouse click or the touch of a touch sensitive screen. An audible signal such as a “click” can be used to indicate when each 1.5 second eye state interval has transpired. Typically, imaging devices are equipped with their own visual indicators that show when an image scan is taking place. Each 1.5 second eye state interval contains one 1.0 second imaging interval. During each 1.5 second eye state interval the user has directed his/her eye to one of the available viewing targets, or the imaging lens, or has closed their eye. During each of the intervals the user has maintained their eye stationary, in the given state, while imaging has occurred. Depending on the alternative method chosen for eye state correlation, one of the following two alternate methods is performed.

Alternative 1: User Particular or Server Side Eye State Correlation

Subsequent to each imaging process, if a raw image based authentication system is being used, the images taken are saved to a data storage buffer which is local to the iris image processing station. If a biometric template based system is to be used, the template is derived after each imaging process, perhaps using a technique similar to that described in U.S. Pat. No. 4,641,349, by Flom et al, or U.S. Pat. No. 5,291,560, by Daugman after which the template is stored to the local buffer. The buffer contents are conveyed to the authentication server with the appropriate communication headers. For the cases where a new account is being set up, the authentication data would be appended with some basic user account registration data such as name, employee number or account number.

Alternative 2: Scanning Station Side General Eye State Correlation

Consistent with this alternative, a “camera view” reference image or it's image derived template is stored to the buffer which is local to the scanning station. Each of the successive imaging processes is followed by an eye state correlation process which involves the mapping of the iris image to a highly smoothed, black and white rendition of the original image. Numerous techniques exist in order to accomplish the smoothing task and any technique chosen that results in an image which is black and white and free from the detail associated with the iris itself would be suitable. Ideally, the resulting image would share the appearance of one of the images shown in FIG. 11. A suitable way of achieving the result would be to iterate through each pixel of the resulting image and generating a corresponding image where every pixel above or below a given threshold of brightness would be assigned a color of white or black respectively. The correlation process has an inherent smoothing effect itself and some spurious effects are well tolerated by the system as a whole. Once the black and white image has been created, a correlation process consistent with the general equation for correlation, given by equation 2, is followed.
CF=∫∫x1·x2·f(x1,x2)·dx1·dx2 (2)
CF denotes “Correlation Factor” and x1 and x2 represent the corresponding points of a joint distribution governing the point sets of x1 and x2. Consistent with the determination of the maximum likelihood eye state which is of importance to our application, we carry out the particular correlation process outlined in equation set 3.

$${CF}_{a} = {\sum }_{row = 1}^{Nrow} {\sum }_{col = 1}^{Ncol} {Candidate}_{i} ( row , col ) \cdot {template}_{a} ( row , col ) \\ {CF}_{b} = {\sum }_{row = 1}^{Nrow} {\sum }_{col = 1}^{Ncol} {Candidate}_{i} ( row , col ) \cdot {template}_{a} ( row , col ) \\ {CF}_{c} = {\sum }_{row = 1}^{Nrow} {\sum }_{col = 1}^{Ncol} {Candidate}_{i} ( row , col ) \cdot {template}_{b} ( row , col ) \\ {CF}_{d} = {\sum }_{row = 1}^{Nrow} {\sum }_{col = 1}^{Ncol} {Candidate}_{i} ( row , col ) \cdot {template}_{c} ( row , col ) \\ {CF}_{e} = {\sum }_{row = 1}^{Nrow} {\sum }_{col = 1}^{Ncol} {Candidate}_{i} ( row , col ) \cdot {template}_{e} ( row , col ) \\ {CF}_{f} = {\sum }_{row = 1}^{Nrow} {\sum }_{col = 1}^{Ncol} {Candidate}_{i} ( row , col ) \cdot {template}_{f} ( row , col ) \qquad ( 3 )$$

Equation set 3 represents the maximum likelihood criteria for determining eye state. A basic point by point correlation equation exists for each of the possibilities which exist for determination of the “i-th” imaged eye state. Assuming eye state correlation patterns for eye states a through f, of the same size and resolution as the black and white images derived from the imaging device, we assign black and white pixels values of +1 and −1, respectively. Pixel by pixel products are computed and summed, in a row by row and column by column fashion. The resulting sums constitute the correlation factor for each possible eye state. The designating subscript a through f, for which the value of CF is the greatest, is the most likely choice for the i-th eye state sent by the authentication candidate. Once the most likely eye states for each of the N−1, non-reference images have been computed, they are stored to the buffer local to the scanning station as the appropriate single character taken from the set {a, b, c, d, e, f}. The buffer contents are conveyed to the authentication server with the appropriate communication headers. For the cases where a new account is being set up, the authentication data would be appended with some basic user account registration data such as name, employee number or account number. This alternative method is most efficient with respect to network resources. It also requires significant computational overhead. Individuals skilled in the art will appreciate the fact that the correlation processes defined can be performed in parallel using dedicated chipsets for cases where superior speed is required.

While it is possible to convey raw image data to the authentication server, and to conduct a generalized eye state correlation process there, to do so would fail to realize the important benefit of dramatically reducing the traffic required between the scanning station(s) and the authentication server. For this reason, the option of transferring raw images to the authentication server, to be correlated against generalized templates for eye state determination, will not be addressed further here.

Appending the Authentication Registries

Once an authentication sequence has been established by the user seeking to register with the authentication server as an authorized account, and the server receives the data, it must process the data and store it for use in all subsequent authentication transactions initiated by the user. In a process peculiar to the creation of an authentication sequence for a user, the server will have to process two sets of authentication data, a registration set and a validation set. The registration set is processed first and is stored in a temporary memory buffer local to the authentication server. The validation set is processed next and is used as a verifier in order to ensure that the initial authentication transaction was recorded and conveyed in a manner that is consistent with how the user intended and that the authentication sequence is sufficiently repeatable so as to fulfill it's purpose. The process is similar to that associated with changing one's password on a computer system.

Considering the overall process in more detail, the initial authentication packet received from the user candidate is stripped of it's user account registration data and a portion or hash of that data is used to name temporary storage areas for the data quantities involved with the registration process. The authentication data includes one camera view reference image and one of the following:
1. N−1 raw iris images
2. N−1 biometric images derived from raw iris images
3. one vector quantity defining the eye states associated with N−1 images

Depending upon whether the iris authentication component of the overall system is to be based upon the correlation of raw iris images, or of image derived templates, the reference image will either be stored directly into a temporary memory location local to the authentication server, or a biometric template derived from the reference image will be saved. Once the reference image or associated template is saved to temporary storage, one of the three following alternatives processes is carried out.

Registration Based upon Raw Image Data

A straightforward means to effect authentication based upon iris characteristics and eye state using identical technology is to simply store the N−1 eye state images in an eye state registry which is keyed to the reference image and by proxy, the authorized user. In order to carry out the registration process based upon this system, the registration reference image and N−1 registration packet eye state images would be saved in N temporary data locations. When the registration authentication packet data has been stored, a message is returned to the scanning station indicating that the validation authentication set should be sent The user candidate would repeat his/her authentication sequence and another authentication packet, complete with registration data and header would be returned to the authentication server. The reference images of the registration and validation sets would be compared using a full image correlation process. The image correlation process could be similar to the generalized eye state correlation process we have presented with the exception being that the images to be compared would have full detail and an appropriate scoring system would be required for generation of the correlation factor. If a suitable match was not found the registration process would be rejected and a rejection message would be sent to the scanning station. If the reference images matched to a suitable degree, the corresponding N−1 eye state images would be compared using the identical image correlation process as that used for the reference images. If a suitable match was not found the registration process would be rejected and a rejection message would be sent to the scanning station. If the eye state images did match to the required degree of certainty (which can be made adjustable by a system administrator), the following tasks are performed by the authentication server:
1. Create an addition to the iris image registry which would contain the raw image of the registration reference image and key such as a unique user account number or string.
2. Create an addition to the eye state registry which would be keyed to the unique user account number or string from part 1, and would contain the N−1 raw images in specific order.
3. Return a message to the scanning station which indicates that the registration process was completed successfully.
4. Delete any interim data sets that were generated or used during the registration process.

For the sake of simplicity, the discussion of the potential use of encryption and/or hash functions was omitted in the foregoing description. Those familiar with modern authentication methods would be aware of where those technologies could be of benefit to the configuration presented.

While the alternative described here is simple, it does not represent a storage efficient alternative, nor is the dual registry configuration described particularly robust against hacker attacks. Other methods that do not involve the direct mapping of the reference image registry entry to the eye state registry entry can be employed. For example, it is possible for a subset of user candidates to be identified initially as being conformal to a given eye state vector. Should the user identified by the reference image be a member of the subset so identified, authentication is granted. For added security with sect to offline hacker attacks on compromised authentication registries, a shared secret approach similar to Diffie-Hellman could be used to link the two registry entries. In effect, each of the registry pairs would provide one component of a solution to logarithmic, finite field equation. It is felt that such methods would be better applied with respect to one of the remaining two alternatives.

Registration Based upon Image Derived Template Data

The process for registering a user based upon a set of image derived biometric templates is similar to the one described for registration based upon raw images. Both cases involve the use of a reference image registry which can be mapped either a one to one sense, or a one to many sense, to an eye state registry. The data within the two registries would be in the form of image derived templates provided from the scanning station, instead of raw images. Though computational overhead would be associated with the process of reducing N images to templates, much less communication bandwidth would be required of the communication medium and the required physical storage within the authentication server would be significantly reduced. The computational overhead associated with each authentication transaction is also reduced from the case where both the candidate image and the registration images must be compared on a raw image basis.

Methods for conducting iris image recognition based upon image derived biometric templates are presented in U.S. Pat. No. 4,641,349, by Flom et al, or U.S. Pat. No. 5,291,560, by Daugman.

Registration Based upon Registration Iris Image Data and Eye State Vector

This method represents the most efficient in terms of communication bandwidth, physical storage and computational overhead of the three registration alternatives provided. Consistent with this method, N−1 successive eye state images are processed and correlated, by the iris image processing station, using a method such as that described in the previous section entitled “Alternative 2: Scanning Station Side General Eye State Correlation”, and the results of the correlation, in the form of a short string vector, are provided with a reference image (or image derived template) to the authentication server. The authentication server then carries out the familiar tasks of;
1. Storing initially received registration data in a temporary buffer and acknowledge receipt to the scanning station while prompting said station for a validation authentication sequence.
2. Comparing received validation authentication sequence with the initially received registration data, approving or rejecting registration attempt as appropriate and acknowledging scanning station with appropriate response.
3. Appending the iris image registry with validated image data of the registration reference image and key such as a unique user account number or string.
4. Creating an addition to the eye state registry which would be keyed to the unique user account number or string from part 1, and would contain the validated eye state vector containing N−1 elements.
5. Delete any interim data sets that were generated or used during the registration process.
   Carrying out an Authentication Transaction on the Scanning Station Side

An example of how the authentication process associated with the new technique would follow the same basic process as that of setting up the authentication profile. The new authentication process can be viewed as a timed sequence of conventional iris recognition authentication transactions. Consequently, the process of authentication can be reinforced by supplementing a reference iris image, with a plurality of additional images that are distinct in that they each capture the authentication candidates eye in varying position states. The position states are established by each user during the registration process described previously. Should the authentication candidate submit a sequence of iris image derived data, which is not reflective of the proper ordered eye states, the authentication process results in a denial of access. A detailed discussion of the scanning station component of the authentication transaction is described in this section. A later section describes the authentication server component of the authentication transaction. A multiplicity of bases by which iris authentication can be conducted was presented in the context of registration processes. For the sake of brevity and to reduce reiteration, the same level of detail with respect to alternative configurations will not be presented here.

A party seeking authentication initiates the timed imaging process by depressing a pushbutton or otherwise initiates the recording process with a mouse click or the touch of a touch sensitive screen. The iris image processing station controls the iris imaging device such that iris images are scanned, in regular intervals, until N total images have been collected. An audible signal such as a “click” can be used to indicate when each eye state interval has transpired. Each eye state interval contains one imaging interval of smaller duration, which is limited by the speed of the overall imaging apparatus. The choice of duration for the eye state interval must be significantly long that a small degree of timing error can be allowed, as the image target acquisition processes between successive transactions, even for the same user, will not correspond exactly. Our test system employs an eye state interval of 1.5 seconds and is associated with an imaging interval of approximately 1 second. During the authentication transaction, the authentication candidate visually acquires one of the 5 viewing targets (including the imaging lens) and may close his or her eyes, for a sixth eye state, during each eye state interval. The recommended implementation dictates that the first image of the N image sequence be a reference image and as such, that it is taken in the camera view position, where the authentication candidate looks directly into the lens of the imaging device. The fact that the first image is of a known eye state determines that the additional uncertainty, or information entropy, imposed by the remaining N−1 eye states, each drawn from a set of 6 possible ones, can be given by equation 4:

$${Entropy}_{( i n bits )} = - ln ( \frac{1}{{6}^{N - 1}} ) \qquad ( 4 )$$

During each of the eye state intervals the user has maintained their eye stationary, in the given state, while imaging has occurred. Subsequent to each imaging process, and consistent with one of a plurality of techniques, one of the following processes is performed by the iris image processing station:
1. An iris image is stored in a memory buffer local to iris image processing station.
2. A biometric template corresponding to the iris image is stored in a memory buffer local to iris image processing station.
3. A generalized eye state correlation process is performed by the iris image processing station which results in a candidate eye state vector which is stored in a memory buffer local to iris image processing station with the reference image data.

Once all N images have been taken and processed, the contents of the buffer local to the iris imaging processing station are configured into a communication data packet, with appropriate header information, and conveyed via the data medium, to the authentication server. The data packet may or may not be encrypted. It is also possible that a non-invertible hash product of the authentication transaction data be provided to the authentication server so that sensitive information need not transit the data medium explicitly. The technologies underlying these options are well known and will not be discussed further in this context.

Carrying out an Authentication Transaction on the Authentication Server Side

Upon receipt of an authentication packet from a scanning station, the packet data content is stored to a memory buffer local to the authentication server. The consistent with the technical alternatives underpinning the recommended implementation, the packet data consists of one reference iris image or image derived biometric template, and N−1 images, or N−1 image derived templates, or one N−1 element eye state vector.

Should raw iris images be provided to the authentication server as a basis for iris and eye state authentication, the underlying correlation process could be based upon the correlation of raw images, or the correlation of templates that the server has derived from the images, or based upon a generalized correlation process for eye state, based upon the patterns provided in FIG. 11, carried out by the server. Each case involves the stripping of the image data, from the memory buffer local to the authentication server, and making an initial, preliminary identification based upon the camera view reference image supplied by the party seeking authentication and the image data maintained in the iris image registry of the authentication server. The preliminary identification process takes place in any manner currently employed for conventional iris recognition systems. If the preliminary identification process does not succeed, an “access is denied” message (which could be in the form of a low pitched, long “beep”) is returned to the party seeking authentication consistent with the sender's routing information included on the communication header associated with the authentication packet. Should preliminary identification succeed, information contained in the iris image registry will reference an entry in the authentication server eye state registry.

As described in an earlier section appearing on page 24, it may be desirable to make an initial one to many identification of the party seeking authentication by identifying first all authorized users which share the same eye state order as the one provided by the authentication candidate, and then searching among them for a reference image match. Though the technique has some important advantages with respect to security against server attacks, it can only be carried out readily in cases where eye state order is determined on a generalized basis.

Once the preliminary identification of the authentication candidate has been made, the server checks to see whether a block has been placed on the user's account. The account block is an integral aspect of the overall security provided by authentication system. Given enough attempts, even the most robust authentication systems can be defeated. A maximum number of failed consecutive authentication attempts, based upon the tested usability of the system must be established such that any attempts to authenticate beyond the allowable number are referred to an offline administration process by which problems with authentication or forgotten eye state orders can be addressed.

If no block exists on the tentatively identified user's account, then, for the case of user particular eye state order correlation, each submitted eye state image, or image derived template, is compared to each of 6 eue state control images. The contro images are stored in the authentication server iris image registry. The result of the process is a candidate eye state order vector defined by the maximum likelihood eye states submitted by the authentication candidate, which is compared to the control eye state order vector maintained by the server eye state order registry.

For the case where raw image data is provided to the server, it would be possible for the process given in the preceding paragraph to be carried out based upon the comparison of biometric templates derived by the authentication server based upon the raw image data provided by the scanning station. Templates so derived would be compared with previously stored templates in the eye state order registry entry associated with the tentatively identified user. Similarly, the generalized eye state correlation process could be performed on the raw image data and the result compared with the eye state order vector stored in the eye state order registry entry associated with the tentatively identified user.

For the case where a generalized eye state correlation process has been carried out by the scanning station and the resulting candidate eye state vector has been conveyed directly to the authentication server, the image or template correlation process described above is not necessary and the candidate and server maintained, control eye state order vectors can be compared directly.

If correspondence is met between the candidate eye state vector and the eye state vector maintained by the server, an “access granted” message (which could be in the form of a high pitched, short “beep”) is returned to the appropriate scanning station, the count of consecutive unsuccessful authentication attempts is zeroed, system interim data counters and buffers are cleared and the server awaits the next authentication packet for processing. Should the candidate and server eye state order vectors not match, the number of consecutive unsuccessful authentication attempts is incremented by one, a block is put on the account if the maximum allowable number of unsuccessful attempts has been exceeded, and an “access denied” message is returned to the authenticating party. Interim data values and buffers are cleared and the server awaits the next authentication packet for processing.

1.) A system for iris recognition having a plurality of functions comprising:
at least one iris recognition imaging device;
a processing station, whereby a sequence of iris imaging processes can be initiated and controlled;
a data storage buffer;
a communication port, whereby digitized sequences made up of scanned and stored iris images or image derived data can be conveyed to an authentication server.

2.) A device which is capable of acquiring a plurality of iris images and conveying said images or data derived from said images across a communication medium.

3.) The device according to claim 2 which can include timing data corresponding to the actions of the party seeking authentication during the successive iris imaging processes with said iris image or image derived data.

4.) The device according to claim 2 by which a plurality of eye states defined by eye position and/or state of eyelid closure can be identified automatically.

5.) The device according to claim 2 which can include iris imaging device selection data corresponding to the iris imaging device choices of the party seeking authentication during the successive iris imaging processes with said iris images or image derived data.

6.) The device according to claim 2 which can include data corresponding to eye position and state of eyelid closure of the party seeking authentication during successive iris imaging processes with said iris images or image derived data.

7.) A device by which iris recognition authentication can be performed based upon adequate matching of a set of one or more iris recognition images or data with a known valid set.

8.) A device according to claim 7 by which authentication can be performed based upon the eye position or state of eyelid closure data associated with said iris images or image derived data.

9.) A device according to claim 7 by which authentication can be performed based upon timing associated with the successive iris imaging processes.

10.) A device according to claim 7 by which authentication can be based upon the iris imaging devices chosen by the party seeking authentication during the successive iris recognition scanning processes.

11.) A process which allows for iris recognition authentication through a plurality of iris recognition data or images for each authenticating party.

12.) A process according to claim 11 which relies on the correct ordering of said iris images or image derived data and images or image derived data describing eye position and/or state of eyelid closure for authentication purposes.

13.) A process according to claim 11 which relies on the correct choice of iris imaging devices for authentication purposes.

14.) A process according to claim 11 and claim 12 which relies on timing data derived from the authenticating party by means of the sequential iris imaging process.

15.) A process according to claim 11 and claim 12 which relies on eye position and/or eyelid closure data not inherent in images of the authenticating party.

16.) Claim includes any circuit or algorithm or combination thereof, which emulates the techniques described herein regardless of the iris imaging technology, timing method, eye position detection and correlation method, iris recognition method, communication method, and candidate-control correlation methods employed.
